(19) United States
(12) Patent Application Publication
(10) Pub. No.: US 2023/0281147 A1
(43) Pub. Date: Sep. 7, 2023

(54) COMMUNICATION APPARATUS, COMMUNICATION METHOD, AND PROGRAM

(71) Applicant: SONY SEMICONDUCTOR SOLUTIONS CORPORATION, KANAGAWA (JP)

(72) Inventors: TAKETOSHI MORIYAMA, KANAGAWA (JP); KOHEI KAWANISHI, KANAGAWA (JP)

(21) Appl. No.: 18/005,762

(22) PCT Filed: Jul. 9, 2021
(86) PCT No.: PCT/JP2021/025921

§ 371 Date: Jan. 17, 2023

(30) Foreign Application Priority Data
Jul. 22, 2020 (JP) 2020-125044

(51) Int. Cl. G06F 13/42

(52) U.S. Cl. CPC G06F 13/42

(57) ABSTRACT

The present disclosure relates to a communication apparatus, a communication method, and a program that are able to improve the communication function regarding the timing of sampling. The communication apparatus includes a link data generation section and a transmission section. The link data generation section generates link data for linking sampling data to the timing at which the sampling data is generated. The transmission section appends the link data to the sampling data and transmits the resulting data to another communication apparatus through a bus. The communication apparatus further includes a time information generation section that generates time information indicating the occurrence time of an event that initiates the sampling of the sampling data. The link data links the time information to the sampling data. The present technology is applicable, for example, to a communication system that establishes communication in compliance with the I3C standard.

### TECHNICAL FIELD

The present disclosure relates to a communication apparatus, a communication method, and a program. More particularly, the present disclosure relates to a communication apparatus, a communication method, and a program that are able to improve the communication function regarding the timing of sampling.

### BACKGROUND ART

Conventionally, the I2C (Inter-Integrated Circuit) standard has been widely adopted as a bus IF (Interface) standard for controlling registers in various types of devices. In recent years, it is demanded that the I2Cs be speeded up and multi-functionalized. Accordingly, MIPI (Mobile Industry Processor Interface) Alliance has formulated and is revising the I3C (Improved Inter Integrated Circuit) standard as the next-generation standard.

For example, the I2C and the I3C are configured so as to establish communication with a slave connected to a bus IF under the control of a master having the initiative of communicating through the bus IF. Further, the I3C has an IBI (In Band Interrupts) function and a timing control function. The IBI function enables the slave connected to the bus IF to issue an interrupt request. The timing control function controls the timing of data transmission.

Disclosed, for example, in PTL 1 is a system that provides a synchronization method for multi-symbols by transmitting a synchronization code on a serial bus and establishing synchronization in response to the synchronization code.

### CITATION LIST

### Patent Literature

### [PTL 1]

JP-T-2017-514394

### SUMMARY

### Technical Problem

Incidentally, when a conventional I3C bus configuration is adopted, for example, the relation between sampling data and the timing at which the sampling data is generated may become unclear. Therefore, it is demanded that the communication function regarding the timing of sampling be improved to clarify the relation between sampling data and the timing at which the sampling data is generated.

The present disclosure has been made in view of the above circumstances to make it possible to improve the communication function regarding the timing of sampling.

### Solution to Problem

A communication apparatus according to an aspect of the present disclosure includes a link data generation section that generates link data for linking sampling data to a timing at which the sampling data is generated, and a transmission section that appends the link data to the sampling data and transmits the resulting data to another communication apparatus through a bus.

A communication method according to an aspect of the present disclosure or a program according to an aspect of the present disclosure includes generating link data for linking sampling data to a timing at which the sampling data is generated, and appending the link data to the sampling data and transmitting the resulting data to another communication apparatus through a bus.

An aspect of the present disclosure generates link data for linking sampling data to a timing at which the sampling data is generated, appends the link data to the sampling data, and transmits the resulting data to another communication apparatus through a bus.

### BRIEF DESCRIPTION OF DRAWINGS

FIG. 1 is a block diagram illustrating a configuration example of an embodiment of a communication system to which the present technology is applied.

FIG. 2 is a diagram illustrating an example of a process of transferring data by using a readout protocol in accordance with a conventional communication method.

FIG. 3 is a diagram illustrating a case where multiple events occur during the use of the conventional communication method.

FIG. 4 is a diagram illustrating an example of a process of transferring data by using a readout protocol in accordance with a communication method to which the present technology is applied.

FIG. 5 is a diagram illustrating a case where multiple events occur during the use of the communication method to which the present technology is applied.

FIG. 6 is a diagram illustrating a configuration example of link data.

FIG. 7 is a diagram illustrating an example of a process of detecting the same event in multiple I3C slaves in accordance with the conventional communication method.

FIG. 8 is a diagram illustrating an example of a process of detecting the same event in multiple I3C slaves in accordance with the communication method to which the present technology is applied.

FIG. 9 is a flowchart illustrating a communication process that is performed by an I3C master in accordance with the conventional communication method.

FIG. 10 is a flowchart illustrating a communication process that is performed by an I3C slave in accordance with the conventional communication method.

FIG. 11 is a flowchart illustrating a communication process that is performed by the I3C master in accordance with the communication method to which the present technology is applied.

FIG. 12 is a flowchart illustrating a communication process that is performed by the I3C slave in accordance with the communication method to which the present technology is applied.

FIG. 13 is a block diagram illustrating a configuration example of an application processor and a sensor device.

FIG. 14 is a circuit diagram illustrating a detailed configuration example of a link data generation section.

FIG. 15 is a diagram illustrating an example of a process of transferring data by using a readout protocol in accordance with the conventional communication method.

FIG. 16 is a diagram illustrating a case where an access request is generated at a timing later than the timing at which sampling 2 is performed during the use of the conventional communication method.

FIG. 17 is a diagram illustrating an example of a process of transferring data by using a readout protocol in accordance with the communication method to which the present technology is applied.

FIG. 18 is a diagram illustrating a case where the access request is generated at a timing later than the timing at which the sampling 2 is performed during the use of the communication method to which the present technology is applied.

FIG. 19 is a diagram illustrating a configuration example of the link data.

FIG. 20 is a flowchart illustrating a communication process that is performed by the I3C master in accordance with the conventional communication method.

FIG. 21 is a flowchart illustrating a communication process that is performed by the I3C slave in accordance with the conventional communication method.

FIG. 22 is a flowchart illustrating a communication process that is performed by the I3C master in accordance with the communication method to which the present technology is applied.

FIG. 23 is a flowchart illustrating a communication process that is performed by the I3C slave in accordance with the communication method to which the present technology is applied.

FIG. 24 is a block diagram illustrating a configuration example of the application processor and the sensor device.

FIG. 25 is a circuit diagram illustrating a detailed configuration example of the link data generation section.

FIG. 26 is a block diagram illustrating a configuration example of the application processor and the sensor device.

FIG. 27 is a circuit diagram illustrating a detailed configuration example of a Sync mode increment circuit.

FIG. 28 is a circuit diagram illustrating a detailed configuration example of an Async mode increment circuit.

FIG. 29 is a block diagram illustrating a configuration example of an embodiment of a computer to which the present technology is applied.

### DESCRIPTION OF EMBODIMENTS

Specific embodiments to which the present technology is applied will now be described with reference to the accompanying drawings.

### Configuration Example of Communication System

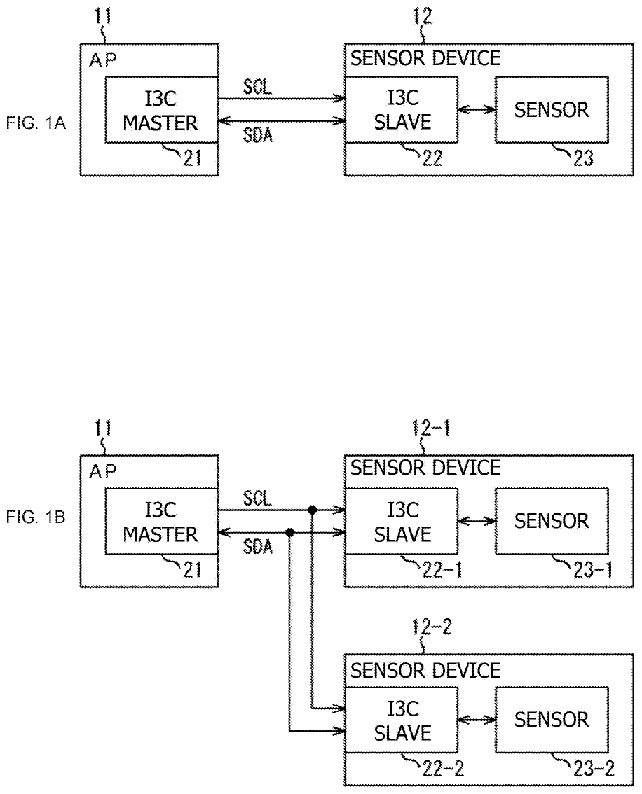

FIG. 1 is a block diagram illustrating a configuration example of an embodiment of a communication system to which the present technology is applied.

The communication system depicted in FIG. 1 is configured such that an application processor 11 and a sensor device 12 are connected through an I3C bus to establish communication in compliance with the I3C standard. The I3C bus includes two signal lines, namely, a signal line for transmitting serial data SDA and a signal line for transmitting a serial clock SCL. For example, the application processor 11 includes an I3C master 21, whereas the sensor device 12 includes an I3C slave 22 and a sensor 23.

The communication system depicted in A of FIG. 1 is configured as an example such that one I3C slave 22 is connected to one I3C master 21. The communication system depicted in B of FIG. 1 is configured as an example such that two I3C slaves 22-1 and 22-2 are connected to one I3C master 21.

The I3C master 21 has the initiative of communicating through the I3C bus. For example, the I3C master 21 controls the communication with the I3C slave 22 by issuing a read request, a write request, or other access request to the I3C slave 22.

The I3C slave 22 is able to communicate through the I3C bus under the communication control of the I3C master 21. It should be noted that the I3C slaves 22-1 and 22-2 have the same configuration.

Various types of sensors, such as an image sensor and a gyro sensor, may be used as the sensor 23. The sensor 23 is able to supply data derived from sensing to the I3C slave 22 at predetermined sampling intervals or in response to a request from the I3C slave 22.

In the communication system configured as described above, the I3C master 21 and the I3C slave 22 are able to communicate by using a later-described communication method to which the present technology is applied.

For example, the I3C slave 22 generates link data for linking sampling data to a timing at which the sampling data is generated, appends the link data to the sampling data, and transmits the resulting data to the I3C master 21 through the I3C bus. Further, the I3C slave 22 is able to generate time information indicating the occurrence time of an event that initiates the sampling of the sampling data, and link the time information to the sampling data by using the link data.

### First Embodiment

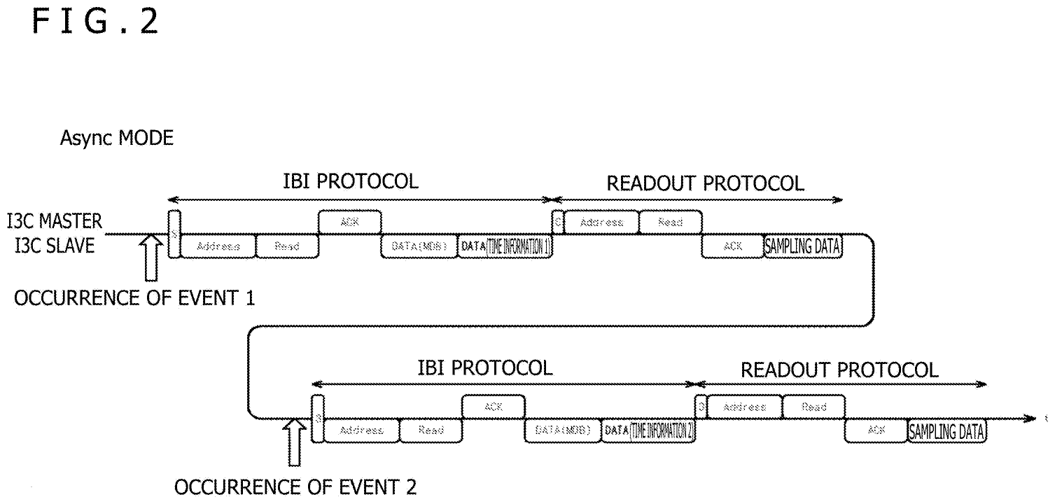

FIGS. 2 to 14 are diagrams illustrating a first embodiment of the communication method to which the present technology is applied.

Referring to FIGS. 2 to 6, an example of a process of transferring data by using a readout protocol will now be described by comparing a conventional communication method with the communication method to which the present technology is applied. The following describes the communication method used in the communication system configured such that one I3C slave 22 is connected to one I3C master 21 as depicted in A of FIG. 1.

When an event 1 occurs as depicted in FIG. 2 while the I3C master 21 and the I3C slave 22 are communicating in an Async mode in accordance with the conventional communication method, the I3C slave 22 generates time information 1 indicating the timing at which the event 1 occurs. Then, the I3C slave 22 transmits MDB data and the time information 1 to the I3C master 21 by using an IBI protocol. Accordingly, the I3C master 21 transmits an access request for requesting read data to the I3C slave 22 by using the readout protocol. Then, the I3C slave 22 sends an ACK response to the access request, and transmits the sampling data, which is obtained by sampling the data regarding the event 1, to the I3C master 21.

Similarly, when an event 2 subsequently occurs, the I3C slave 22 generates time information 2 indicating the timing at which the event 2 occurs. Then, the I3C slave 22 transmits the MDB data and the time information 2 to the I3C master 21 by using the IBI protocol. Accordingly, the I3C master 21 transmits the access request for requesting read data to the I3C slave 22 by using the readout protocol. Then, the I3C slave 22 sends an ACK response to the access request, and transmits the sampling data, which is obtained by sampling the data regarding the event 2, to the I3C master 21.

In a case where the above-described conventional communication method is used, a sampling timing at which the sampling data is sampled may become unknown in a case where multiple events occur.

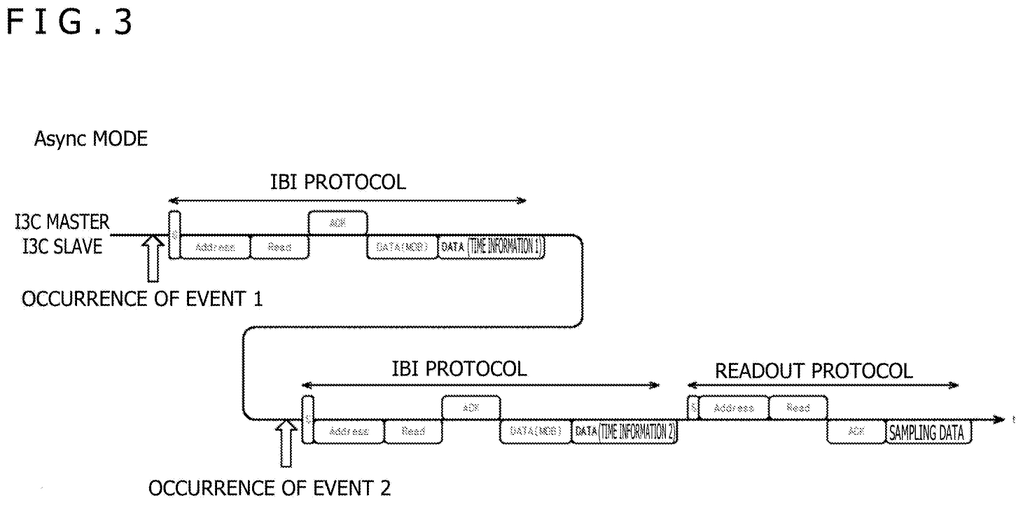

FIG. 3 is a diagram illustrating a case where multiple events occur and the sampling timing at which the sampling data is sampled becomes unknown.

Specifically, as depicted in FIG. 3, in a case where the event 2 occurs immediately after the end of the IBI protocol, which transmits the time information 1 in response to the occurrence of the event 1, the IBI protocol for transmitting the time information 2 in response to the occurrence of the event 2 may be executed without executing the readout protocol for transmitting the sampling data regarding the event 1. In such an instance, even if the readout protocol is executed after the execution of the IBI protocol for transmitting the time information 2 in response to the occurrence of the event 2, the sampling timing of the sampling data transmitted by the readout protocol becomes unknown. That is, it is not possible to identify whether the sampling data transmitted by the readout protocol relates to the event 1 or the event 2.

In view of the above circumstances, the communication method to which the present technology is applied utilizes the link data for linking the time information to the sampling data and thus avoids a situation where the sampling timing of the sampling data becomes unknown even in a case where multiple events occur.

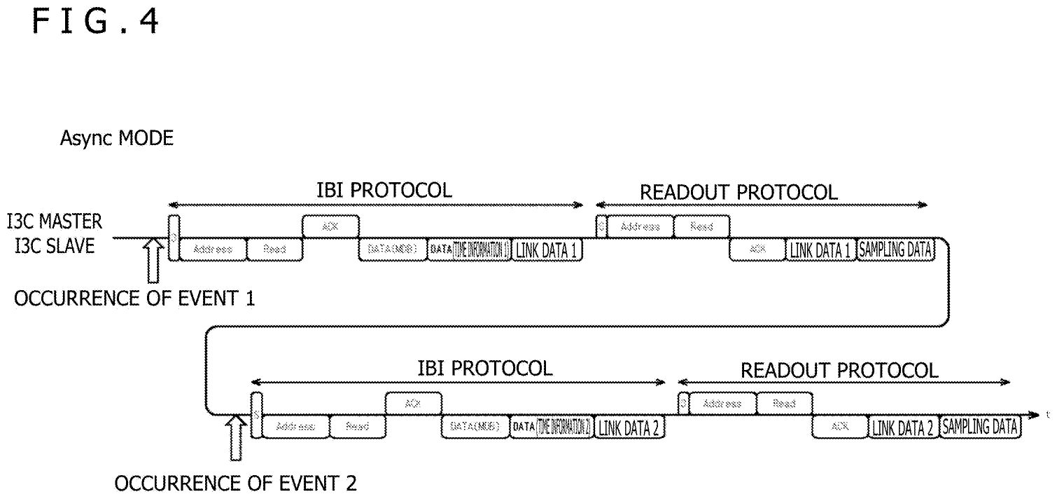

As depicted in FIG. 4, if the event 1 occurs while the I3C master 21 and the I3C slave 22 are communicating in the Async mode, the communication method to which the present technology is applied causes the I3C slave 22 to generate the time information 1, which indicates the timing at which the event 1 occurs. Then, by using the IBI protocol, the I3C slave 22 transmits, to the I3C master 21, not only the MDB data and the time information 1 but also link data 1, which links the time information 1 to the sampling data regarding the event 1. Accordingly, the I3C master 21 uses the readout protocol to transmit an access request for requesting read data to the I3C slave 22. Then, the I3C slave 22 sends an ACK response to the access request, and transmits the sampling data regarding the event 1 to the I3C master 21 subsequently to the transmission of the link data 1.

Similarly, when the event 2 subsequently occurs, the I3C slave 22 generates the time information 2 indicating the timing at which the event 2 occurs. Then, by using the IBI protocol, the I3C slave 22 transmits, to the I3C master 21, not only the MDB data and the time information 2 but also link data 2, which links the time information 2 to the sampling data regarding the event 2. Accordingly, the I3C master 21 uses the readout protocol to transmit an access request for requesting read data to the I3C slave 22. Then, the I3C slave 22 sends an ACK response to the access request, and transmits the sampling data regarding the event 2 to the I3C master 21 subsequently to the transmission of the link data 2.

As described above, the communication method to which the present technology is applied utilizes the link data to avoid a situation where the sampling timing at which the sampling data is sampled becomes unknown even in a case where multiple events occur.

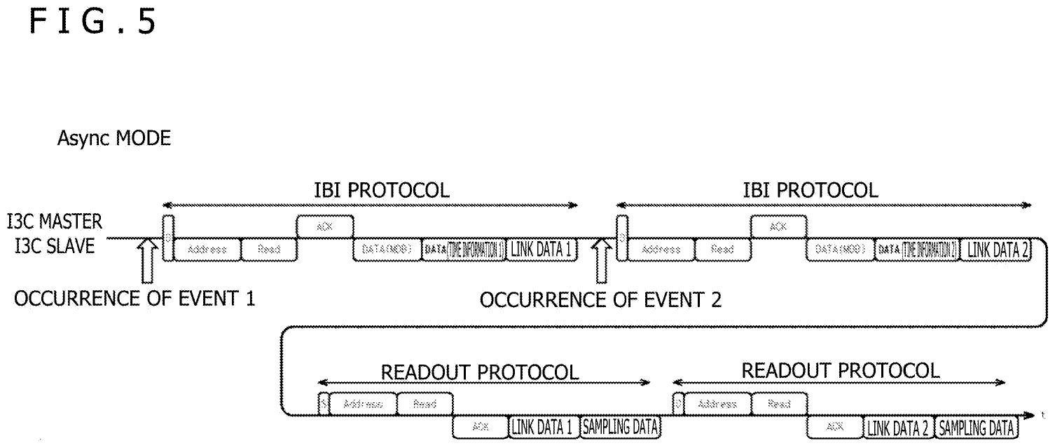

FIG. 5 is a diagram illustrating that the sampling timing at which the sampling data is sampled can be identified even in a case where multiple events occur.

That is, as depicted in FIG. 5, in a case where the event 2 occurs immediately after the end of the IBI protocol for transmitting the time information 1 in response to the occurrence of the event 1, the IBI protocol for transmitting the time information 2 is subsequently executed in response to the occurrence of the event 2. In this instance, the link data 1 is transmitted in addition to the time information 1, and the link data 2 is transmitted in addition to the time information 2. Subsequently, the readout protocol is executed to transmit the sampling data regarding the event 1 subsequently to the transmission of the link data 1, and then the readout protocol is further executed to transmit the sampling data regarding the event 2 subsequently to the transmission of the link data 2.

As described above, even in a case where multiple events occur, the I3C master 21 is able to link the sampling data regarding the event 1 to the time information 1 in accordance with the link data 1, and link the sampling data regarding the event 2 to the time information 2 in accordance with the link data 2. Therefore, the I3C master 21 is able to recognize the sampling timing of the sampling data regarding the event 1 in accordance with the time information 1, and recognize the sampling timing of the sampling data regarding the event 2 in accordance with the time information 2.

Consequently, the I3C master 21 is able to individually recognize the sampling timings of the sampling data that is sampled multiple times. This makes it possible, for example, to simultaneously transmit multiple pieces of the sampling data at a timing within a bus bandwidth. That is, even when multiple pieces of the sampling data are simultaneously transmitted at a timing within the bus bandwidth, the I3C master 21 is able to avoid a situation where the sampling timings of individual pieces of the sampling data become unknown.

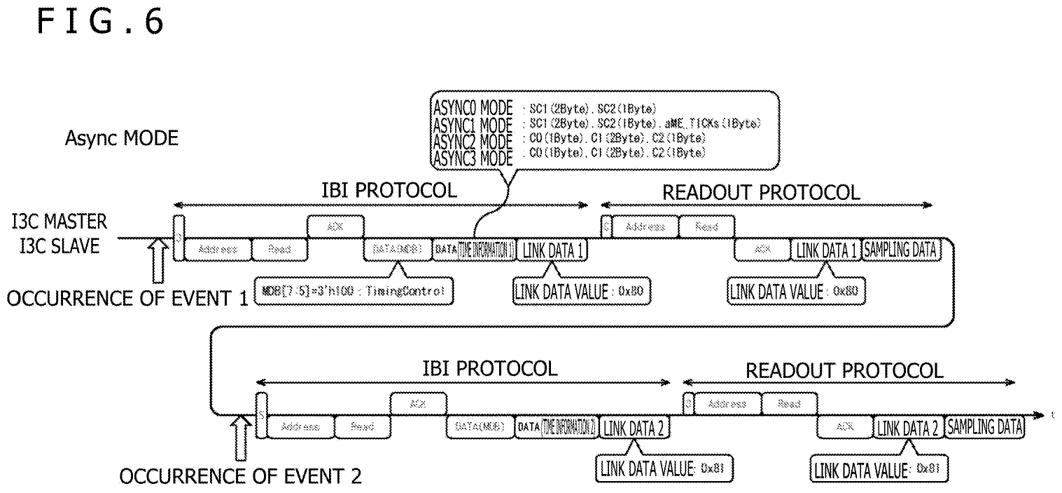

Referring now to FIG. 6, the diagram illustrates a configuration example of the link data that uses an ID value for making the sampling data identifiable.

For example, as depicted in FIG. 6, the link data is defined as one byte, and the most significant one bit indicates that sampling is performed under Async mode control or under Sync mode control, whereas the remaining bits are incremented upon each occurrence of an event.

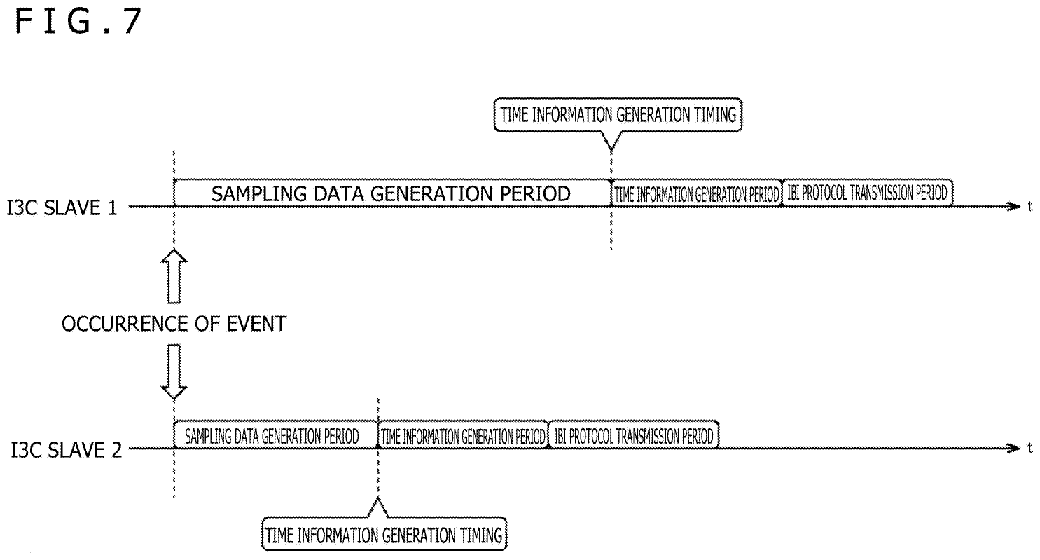

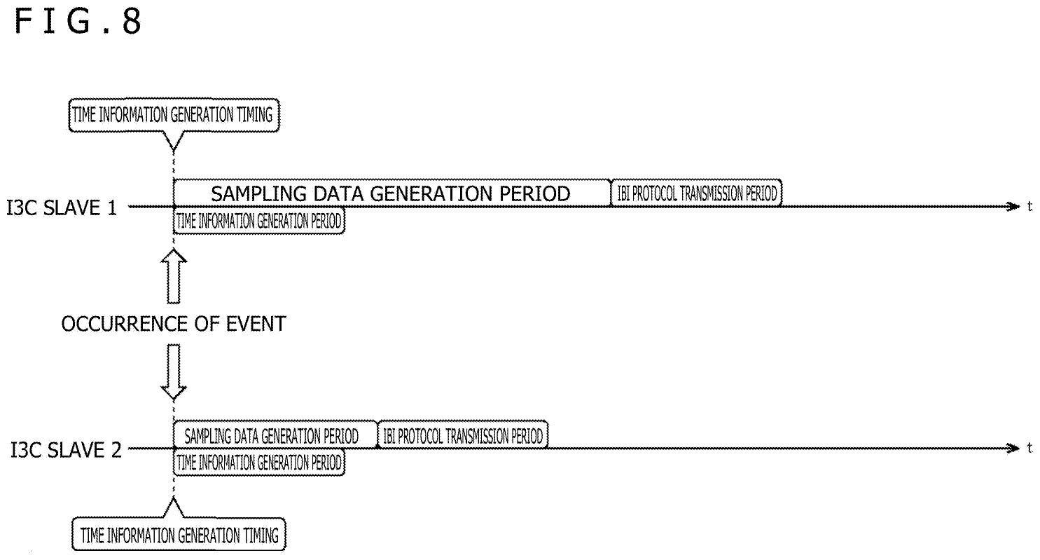

Referring now to FIGS. 7 and 8, examples of a process of detecting the same event in multiple I3C slaves will be described by comparing the conventional communication method with the communication method to which the present technology is applied. The following describes the communication method used in the communication system configured such that two I3C slaves 22-1 and 22-2 are connected to one I3C master 21 as depicted in B of FIG. 1. Further, the examples of the process described with reference to FIGS. 7 and 8 assume that the I3C slave 22-1 uses, for example, an image sensor or other sensor requiring a long sampling data generation time, and that the I3C slave 22-2 uses, for example, a gyro sensor or other sensor requiring a short sampling data generation time.

As depicted in FIG. 7, when the conventional communication method is used, the I3C slave 22-1 starts a sampling data generation period in response to the occurrence of an event, and consecutively implements the sampling data generation period, a time information generation period, and an IBI protocol transmission period. Therefore, the I3C slave 22-1 generates time information during the time information generation period by using the end time of sampling data generation during the sampling data generation period as a time information generation timing for starting the generation of time information indicative of the time at which the generation of the sampling data starts. Subsequently, the I3C slave 22-1 transmits the sampling data and the time information by using the IBI protocol during the IBI protocol transmission period.

Similarly, the I3C slave 22-2 starts the sampling data generation period in response to the occurrence of the event, and consecutively implements the sampling data generation period, the time information generation period, and the IBI protocol transmission period. Therefore, the I3C slave 22-2 generates time information during the time information generation period by using the end time of sampling data generation during the sampling data generation period as a time information generation timing for generating the time information. Subsequently, the I3C slave 22-1 transmits the sampling data and the time information by using the IBI protocol during the IBI protocol transmission period.

When the above-described conventional communication method is used, although the I3C slaves 22-1 and 22-2 generate the sampling data regarding the same event, the I3C slaves 22-1 and 22-2 transmit different pieces of time information by using the IBI protocol because the I3C slaves 22-1 and 22-2 generate the time information at different timings. Therefore, the I3C master 21 may fail to recognize that the sampling data generated by the I3C slaves 22-1 and 22-2 relate to the same detected event.

Accordingly, as depicted in FIG. 8, the communication method to which the present technology is applied, in response to the occurrence of an event, makes a timing at which the sampling data generation period starts coincide with a timing at which the time information generation period starts, and parallelly implements the sampling data generation period and the time information generation period. Subsequently, at the end of the sampling data generation period of each I3C slave, the IBI protocol transmission period is implemented to transmit the sampling data and the time information.

Consequently, the I3C slaves 22-1 and 22-2 are able to generate the time information at the same time information generation timing. As a result, the same time information is transmitted by using the IBI protocol. This enables the I3C master 21 to recognize that the sampling data generated by the I3C slaves 22-1 and 22-2 relate to the same detected event.

### Communication Processing

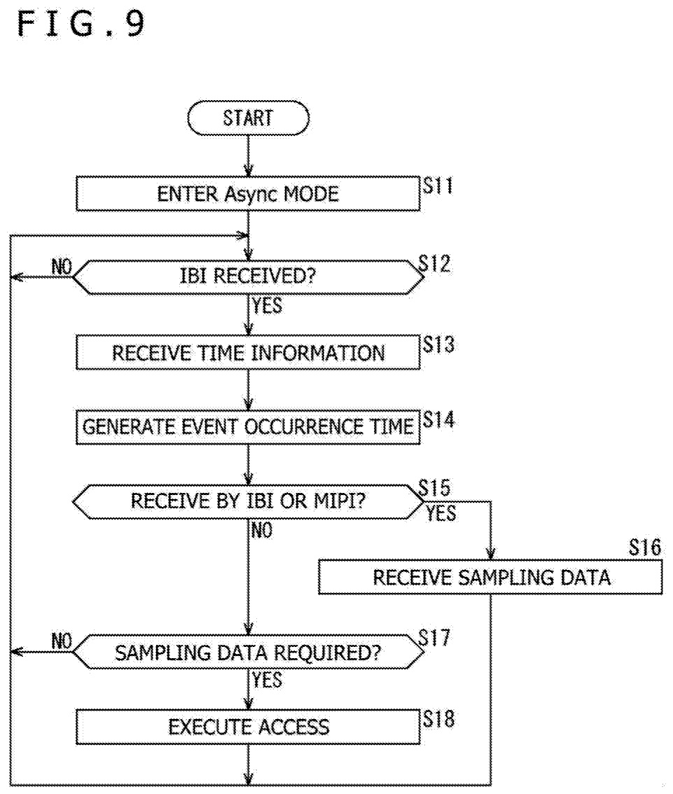

Communication processing performed in the first embodiment will now be described with reference to FIGS. 9 to 12.

FIG. 9 is a flowchart illustrating a communication process that is performed by the I3C master 21 in accordance with the conventional communication method.

In step S11, the I3C master 21 starts communicating with the I3C slave 22 in the Async mode.

In step S12, the I3C master 21 determines whether or not an IBI transferred from the I3C slave 22 is received, and stands by for processing until it is determined that the IBI is received. Subsequently, in a case where the I3C master 21 determines that the IBI has been received, the processing proceeds to step S13.

In step S13, the I3C master 21 acquires time information that is transferred by the IBI from the I3C slave 22. In step S14, the I3C master 21 generates event generation time in accordance with the time information acquired in step S13.

In step S15, the I3C master 21 determines whether or not to receive sampling data by an IBI or by an MIPI.

In a case where the I3C master 21 determines in step S15 to receive the sampling data either by the IBI or by the MIPI, the processing proceeds to step S16. In step S16, the I3C master 21 receives the sampling data by the IBI or by the MIPI. Upon completion of step S16, the processing returns to step S12. In step S12 and beyond, the processing is repeatedly performed in a similar manner.

Meanwhile, in a case where the I3C master 21 determines in step S15 not to receive the sampling data by the IBI or by the MIPI, the processing proceeds to step S17.

In step S17, the I3C master 21 determines whether or not the sampling data is required. In a case where it is determined that the sampling data is not required, the processing returns to step S12. In step S12 and beyond, the processing is repeatedly performed in the similar manner.

Meanwhile, in a case where the I3C master 21 determines, in step S17, that the sampling data is required, the processing proceeds to step S18. In step S18, the I3C master 21 executes access in order to request the I3C slave 22 to read out the sampling data, and receives the sampling data as a result of the access. Subsequently, the processing returns to step S12. In step S12 and beyond, the processing is repeatedly performed in the similar manner.

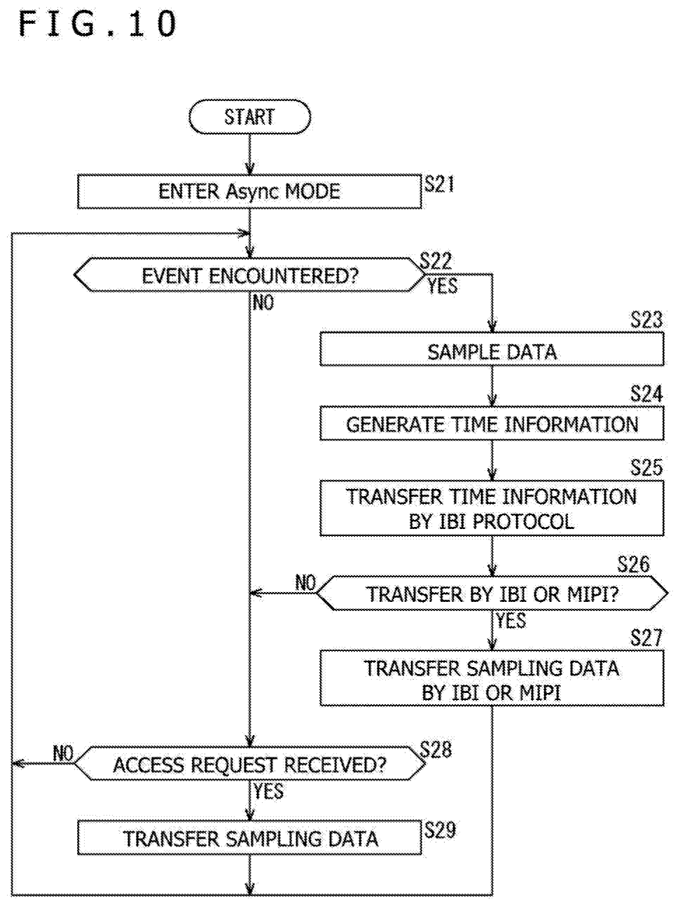

FIG. 10 is a flowchart illustrating a communication process that is performed by the I3C slave 22 in accordance with the conventional communication method.

In step S21, the I3C slave 22 starts communicating with the I3C master 21 in the Async mode.

In step S22, the I3C slave 22 determines whether or not an event has occurred. In a case where it is determined that an event has occurred, the processing proceeds to step S23.

In step S23, the I3C slave 22 samples data regarding the event to generate sampling data. Subsequently, in step S24, the I3C slave 22 generates time information at a time information generation timing (see FIG. 7). In step S25, the I3C slave 22 transfers the time information to the I3C master 21 by using the IBI protocol.

In step S26, the I3C slave 22 determines whether or not to transfer the sampling data by the IBI or by the MIPI.

In a case where the I3C slave 22 determines, in step S26, to transfer the sampling data either by the IBI or by the MIPI, the processing proceeds to step S27. In step S27, the I3C slave 22 transfers the sampling data by the IBI or by the MIPI. Upon completion of step S27, the processing returns to step S22. In step S22 and beyond, the processing is repeatedly performed in a similar manner.

Meanwhile, in a case where it is determined, in step S22, that no event has occurred or it is determined, in step S26, not to transfer the sampling data by the IBI or by the MIPI, the processing proceeds to step S28.

In step S28, the I3C slave 22 determines whether or not an access request for reading out the sampling data is received. In a case where it is determined that the access request is not received, the processing returns to step S22. In step S22 and beyond, the processing is repeatedly performed in the similar manner.

Meanwhile, in a case where the I3C slave 22 determines, in step S28, that the access request for reading out the sampling data is received, the processing proceeds to step S29. In step S29, the I3C slave 22 transfers the sampling data in response to the access request from the I3C master 21. Subsequently, the processing returns to step S22. In step S22 and beyond, the processing is repeatedly performed in the similar manner.

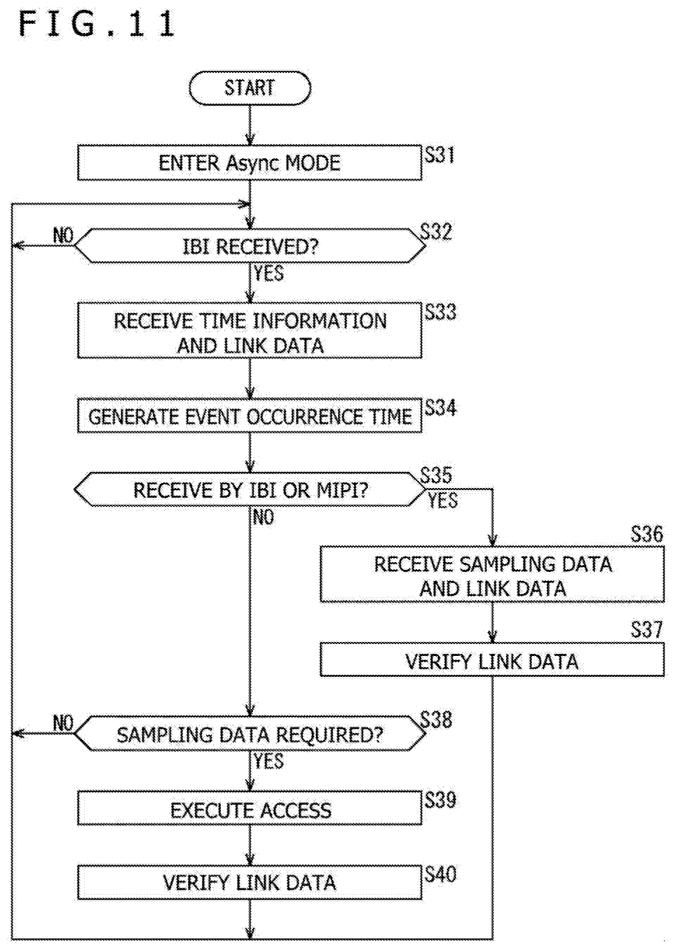

FIG. 11 is a flowchart illustrating a communication process that is performed by the I3C master 21 in accordance with a communication method to which the present technology is applied.

In steps S31 and S32, the processing is performed in a similar manner to the processing in steps S11 and S12 of FIG. 9.

In step S33, the I3C master 21 acquires time information and link data that are transferred by the IBI from the I3C slave 22.

In steps S34 and S35, the processing is performed in a similar manner to the processing in steps S14 and S15 of FIG. 9.

In step S36, the I3C master 21 receives sampling data and link data by the IBI or by the MIPI. In step S37, the I3C master 21 verifies the link data. Upon completion of step S37, the processing returns to step S32. In step S32 and beyond, the processing is repeatedly performed in a similar manner.

In step S38, the processing is performed in a similar manner to the processing in step S17 of FIG. 9.

In step S39, the I3C master 21 executes access in order to request the I3C slave 22 to read out the sampling data, and receives the sampling data and the link data as a result of the access. In step S40, the I3C master 21 verifies the link data. Upon completion of step S40, the processing returns to step S32. In step S32 and beyond, the processing is repeatedly performed in the similar manner.

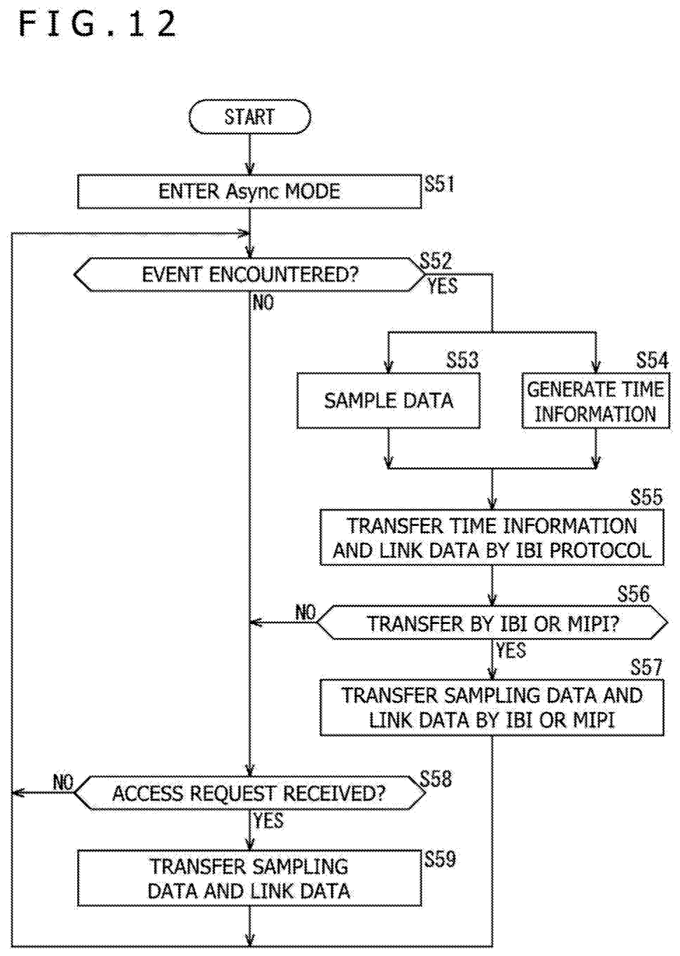

FIG. 12 is a flowchart illustrating a communication process that is performed by the I3C slave 22 in accordance with the communication method to which the present technology is applied.

In steps S51 and S52, the processing is performed in a similar manner to the processing in steps S21 and S22 of FIG. 10. In a case where it is determined, in step S52, that an event has occurred, the processing parallelly proceeds to steps S53 and S54.

Steps S53 and S54 are parallelly performed by the I3C slave 22. More specifically, in step S53, the I3C slave 22 samples data regarding the event to generate sampling data, and in step S54, the I3C slave 22 generates time information at a time information generation timing (see FIG. 8). Further, in step S54, the I3C slave 22 generates link data for linking the generated time information to the sampling data.

In step S55, the I3C slave 22 transfers the time information and the link data to the I3C master 21 by using the IBI protocol.

In step S56, the processing is performed in a similar manner to the processing in step S26 of FIG. 10.

In step S57, the I3C slave 22 transfers the sampling data and the link data by the IBI or by the MIPI. Upon completion of step S57, the processing returns to step S52. In step S52 and beyond, the processing is repeatedly performed in a similar manner.

In step S58, the processing is performed in a similar manner to the processing in step S28 of FIG. 10.

In step S59, the I3C slave 22 transfers the sampling data and the link data in response to the access request from the I3C master 21. Subsequently, the processing returns to step S52. In step S52 and beyond, the processing is repeatedly performed in the similar manner.

### Configuration Example of Application Processor and Sensor Device

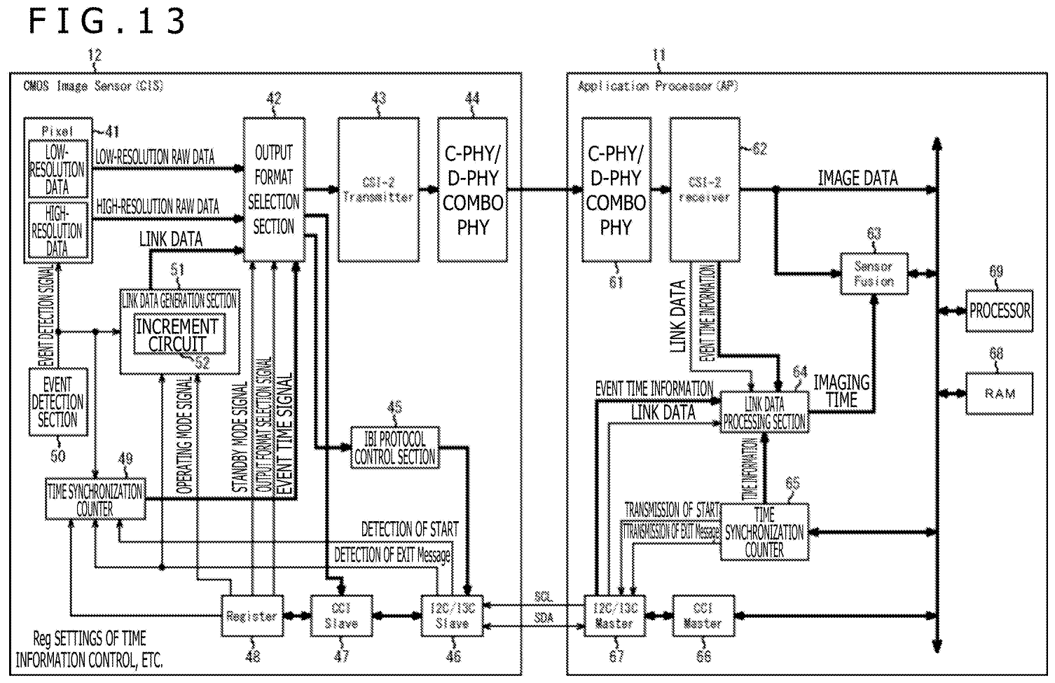

FIG. 13 is a block diagram illustrating a configuration example of the application processor 11 and the sensor device 12.

As depicted in FIG. 13, the sensor device 12 includes pixels 41, an output format selection section 42, a CSI-2 transmitter 43, a combo physical layer 44, an IBI protocol control section 45, an I2C/I3C slave 46, a CCI slave 47, a register 48, a time synchronization counter 49, an event detection section 50, and a link data generation section 51. Further, the link data generation section 51 includes an increment circuit 52. The application processor 11 includes a combo physical layer 61, a CSI-2 receiver 62, a sensor fusion section 63, a link data processing section 64, a time synchronization counter 65, a CCI master 66, an I2C/I3C master 67, a RAM 58, and a processor 59.

Here, the I2C/I3C slave 46 corresponds to the I3C slave 22 in FIG. 1, and the I2C/I3C master 67 corresponds to the I3C master 21 in FIG. 1. Further, in the configuration example depicted in FIG. 13, a CMOS image sensor is used as the sensor device 12, and the sensor 23 depicted in FIG. 1 includes the pixels 41.

The pixels 41 perform imaging to generate image data, and supply low-resolution RAW data or high-resolution RAW data to the output format selection section 42. The output format selection section 42 generates image data to be transferred to the application processor 11 in accordance with an output format selection signal based on the settings defined in the register 48, and supplies the generated image data to the CSI-2 transmitter 43, the IBI protocol control section 45, or the CCI slave 47. The CSI-2 transmitter 43 performs a process for transmitting image data in accordance with a CSI-2 protocol, and supplies the image data to the combo physical layer 44. The combo physical layer 44 controls MIPI-compliant communication to transmit the image data to the application processor 11 by C-PHY or D-PHY.

The IBI protocol control section 45 generates IBI transfer data from the image data supplied from the output format selection section 42, and supplies the IBI transfer data to the I2C/I3C slave 46. The I2C/I3C slave 46 controls an I2C/I3C protocol to append link data to the image data, and transmits the resulting data to the application processor 11 through an I2C/I3C bus. The CCI slave 47 controls a CCI protocol, for example, to write settings into the register 48.

The time synchronization counter 49 acts as a counter block for providing a reference time in the Async mode, and supplies the count of the timing at which an event detection signal is supplied from the event detection section 50 (time information indicating the occurrence time of an event causing the pixels 41 to generate image data) to the output format selection section 42 as an event time signal. Upon detecting an event, the event detection section 50 supplies the event detection signal to the pixels 41, the time synchronization counter 49, and the link data generation section 51. The link data generation section 51 generates link data based on a mode according to an operating mode signal of the register 48 (data for linking image data to time information indicating the timing at which the image data is generated by the pixels 41), and supplies the link data to the output format selection section 42.

The combo physical layer 61 controls MIPI-compliant communication to acquire image data transmitted from the combo physical layer 44 by C-PHY or D-PHY, and supplies the image data to the CSI-2 receiver 62. The CSI-2 receiver 62 receives the image data in accordance with the CSI-2 protocol, and supplies the image data to the sensor fusion section 63. The sensor fusion section 63 associates an image supplied from the CSI-2 receiver 62 with an imaging time supplied from the link data processing section 64.

The link data processing section 64 verifies the link data, and determines the imaging time by associating the link data with the time information in the Sync mode or associating the link data with event time information in the Async mode. The time synchronization counter 65 acts as a counter block for providing a reference time in the Sync mode, and supplies the time information to the link data processing section 64. The CCI master 66 controls the CCI protocol, whereas the I2C/I3C master 67 controls the I2C/I3C protocol.

The RAM 58 stores various data such as image data. The processor 59 controls MIPI communication and I3C communication in accordance with the program.

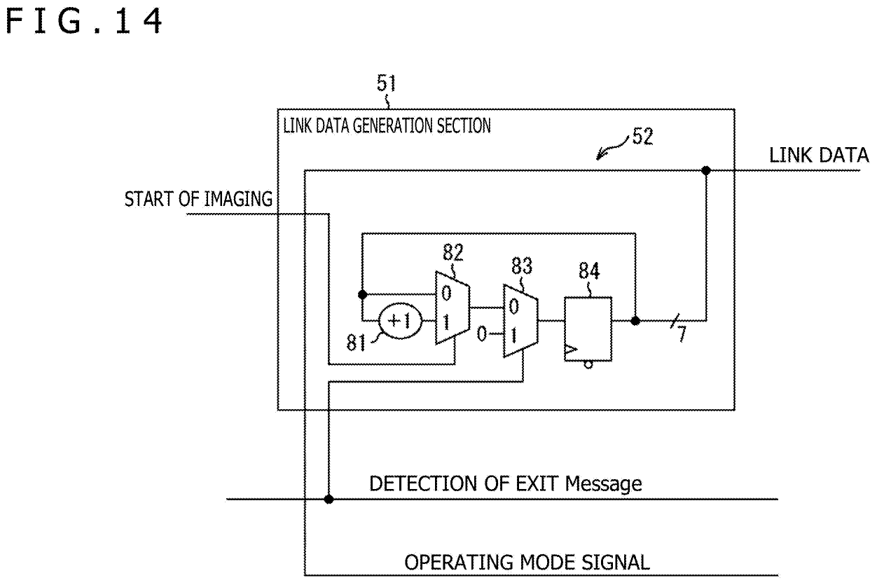

FIG. 14 is a circuit diagram illustrating a detailed configuration example of the link data generation section 51.

As depicted in FIG. 14, the increment circuit 52 included in the link data generation section 51 includes an adder 81, a selection section 82, a selection section 83, and a latch 84.

### Second Embodiment

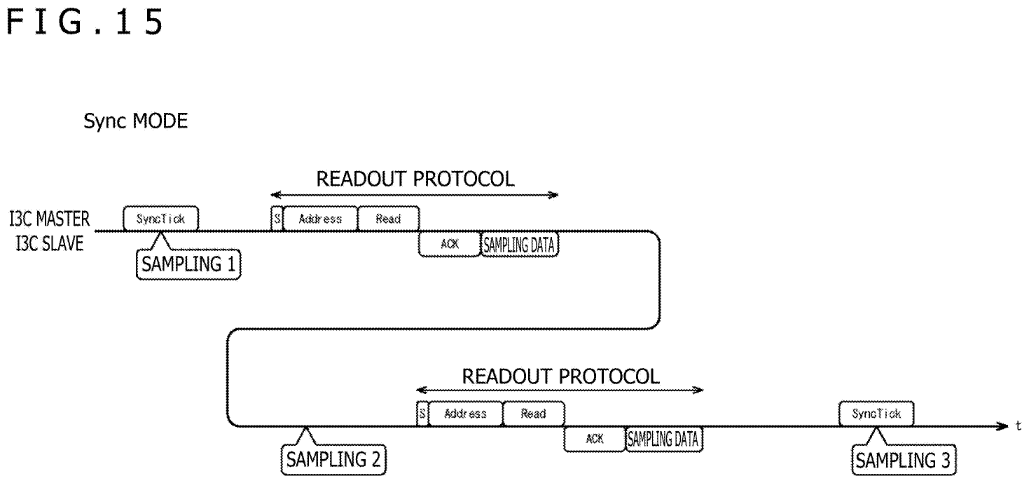

FIGS. 15 to 28 are diagrams illustrating a second embodiment of the communication method to which the present technology is applied.

Referring to FIGS. 15 to 19, an example of a process of transferring data by using the readout protocol will now be described by comparing a conventional communication method with the communication method to which the present technology is applied. The following describes the communication method used in the communication system configured such that one I3C slave 22 is connected to one I3C master 21 as depicted in A of FIG. 1.

As depicted in FIG. 15, while the I3C master 21 and the I3C slave 22 are communicating in the Sync mode, the conventional communication method causes the I3C master 21 to issue a Sync Tick, and causes the I3C slave 22 to perform sampling 1 in accordance with the Sync Tick. Subsequently, the I3C master 21 uses the readout protocol to transmit an access request for requesting read data to the I3C slave 22. Then, the I3C slave 22 sends an ACK response to the access request, and transmits sampling data, which is obtained by sampling data of the sampling 1, to the I3C master 21.

Further, the I3C slave 22 performs sampling 2 at a timing at which a predetermined period of time has elapsed since the Sync Tick. Subsequently, the I3C master 21 uses the readout protocol to transmit an access request for requesting read data to the I3C slave 22. Then, the I3C slave 22 sends an ACK response to the access request, and transmits sampling data, which is obtained by sampling data of the sampling 2, to the I3C master 21.

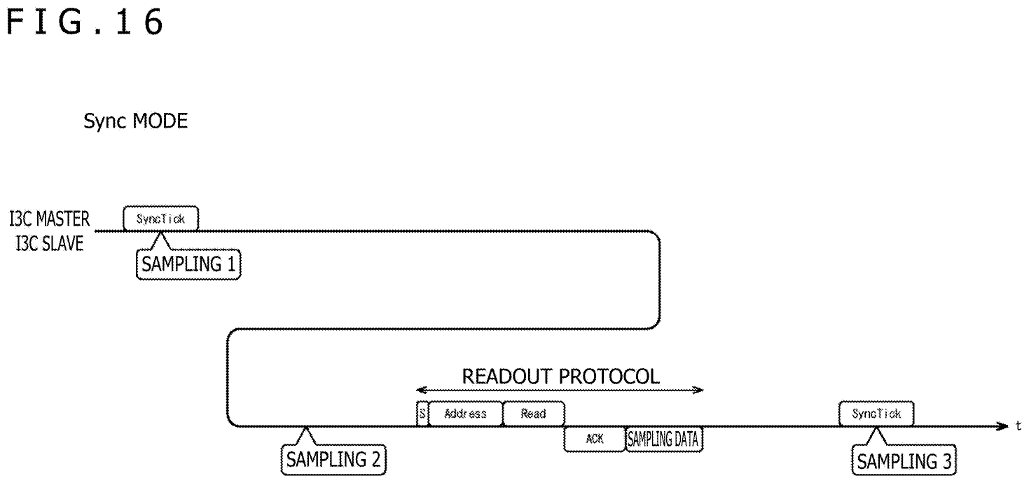

When the above-described conventional communication method is used, a sampling timing at which the sampling data is sampled may become unknown in a case where an access request for requesting read data is issued at a timing later than the timing at which the sampling 2 is performed as depicted in FIG. 16. That is, it is not possible to identify whether or not the sampling data transmitted by using the readout protocol in the above manner relates to the sampling 1 or the sampling 2.

In view of the above circumstances, the communication method to which the present technology is applied utilizes link data for linking a sampling timing to sampling data and thus avoids a situation where the sampling timing of the sampling data becomes unknown.

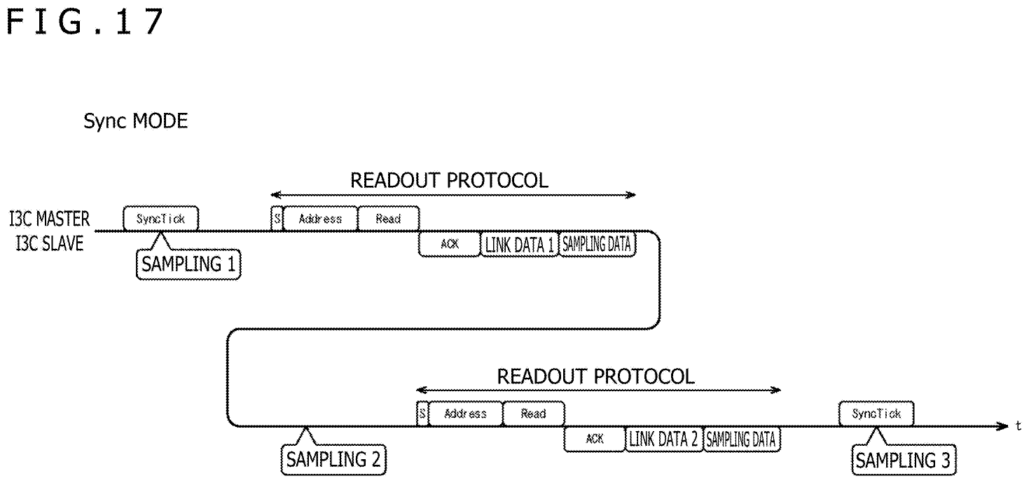

As depicted in FIG. 17, when the sampling 1 is performed in accordance with the Sync Tick while the I3C master 21 and the I3C slave 22 are communicating in the Sync mode, the communication method to which the present technology is applied causes the I3C slave 22 to generate the link data 1 indicative of the sampling timing of the sampling 1. Subsequently, the I3C master 21 transmits an access request for requesting read data to the I3C slave 22 by using the readout protocol. Then, the I3C slave 22 sends an ACK response to the access request, and transmits the sampling data regarding the sampling 1 to the I3C master 21 subsequently to the transmission of the link data 1.

Further, the I3C slave 22 performs the sampling 2 at the timing at which a predetermined period of time has elapsed since the Sync Tick. In this instance, the I3C slave 22 generates the link data 2 indicative of the sampling timing of the sampling 2. Subsequently, the I3C master 21 uses the readout protocol to transmit an access request for requesting read data to the I3C slave 22. Then, the I3C slave 22 sends an ACK response to the access request, and transmits the sampling data regarding the sampling 2 to the I3C master 21 subsequently to the transmission of the link data 2.

As described above, the communication method to which the present technology is applied uses the link data that links sampling data generated by sampling performed at periodic timings to the sampling timing at which the sampling data is sampled. Therefore, even in a case where an access request is made for read data at a timing later than the timing at which the sampling 2 is performed, it is possible to avoid a situation where sampling timings at which sampling data 1 and sampling data 2 are sampled becomes unknown.

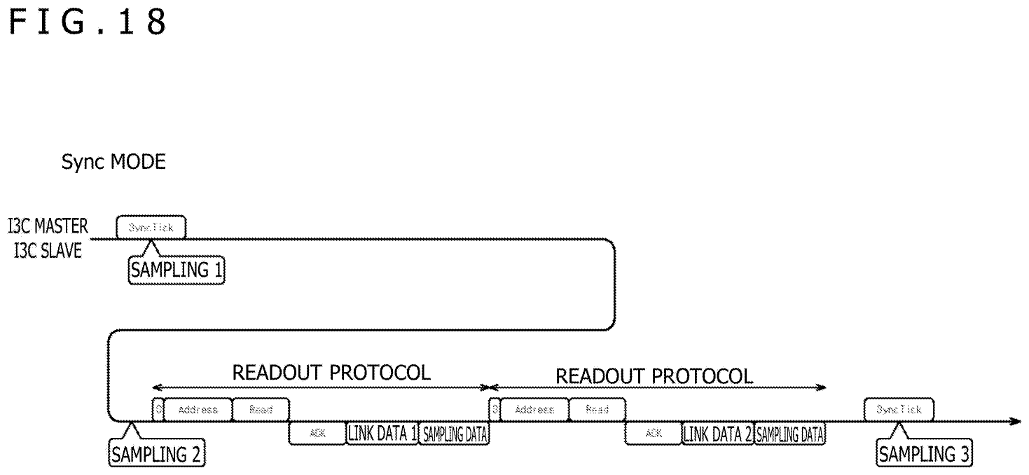

FIG. 18 is a diagram illustrating a situation where the sampling timings at which the sampling data 1 and the sampling data 2 are sampled can be identified even in a case where an access request is made for read data at a timing later than the timing at which the sampling 2 is performed.

More specifically, it is assumed that a case where, as depicted in FIG. 18, after the sampling 1 is performed in accordance with the Sync Tick, the sampling 2 is performed without an access request at the timing at which a predetermined period of time has elapsed since the Sync Tick. In this case, too, the I3C slave 22 sends an ACK response to the access request, and transmits the sampling data regarding the sampling 1 to the I3C master 21 subsequently to the transmission of the link data 1. Afterwards, the I3C slave 22 sends an ACK response to the access request, and transmits the sampling data regarding the sampling 2 to the I3C master 21 subsequently to the transmission of the link data 2. Therefore, the I3C master 21 is able to recognize the sampling timing of the sampling data regarding the sampling 1 in accordance with the link data 1, and recognize the sampling timing of the sampling data regarding the sampling 2 in accordance with the link data 2.

Consequently, the I3C master 21 is able to individually recognize the sampling timings of the sampling data that is sampled multiple times. This makes it possible, for example, to simultaneously transmit multiple pieces of the sampling data at a timing within a bus bandwidth. That is, even when multiple pieces of the sampling data are simultaneously transmitted at a timing within the bus bandwidth, the I3C master 21 is able to avoid a situation where the sampling timings of individual pieces of the sampling data become unknown.

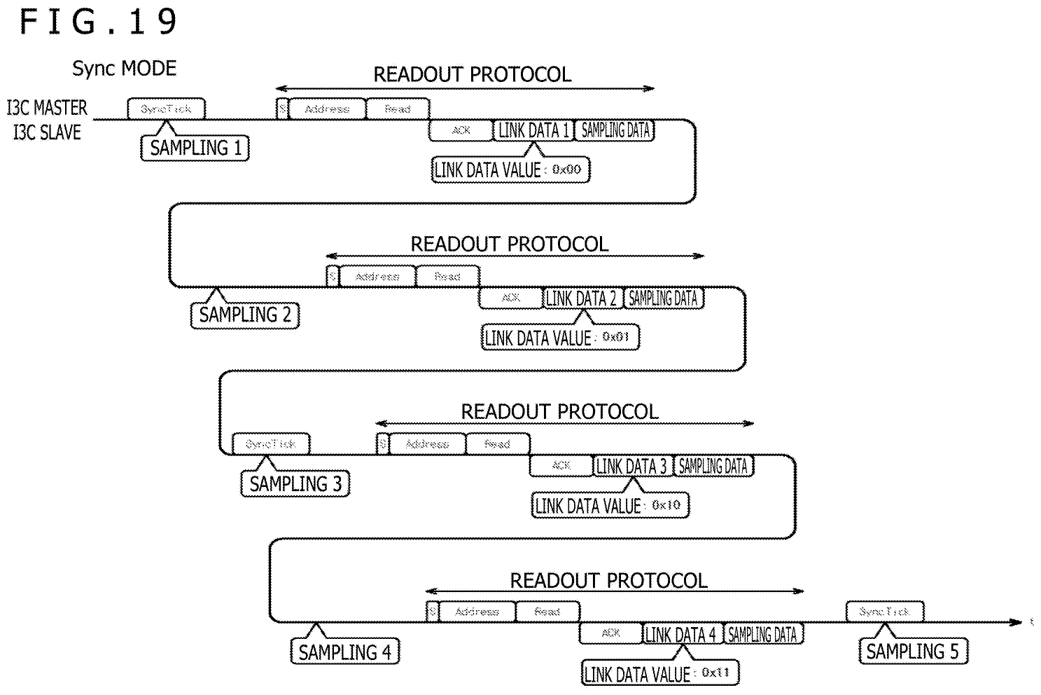

Referring now to FIG. 19, the diagram illustrates a configuration example of the link data that uses an ID value for making the sampling data identifiable.

For example, as depicted in FIG. 19, the most significant one bit indicates that sampling is performed under Async mode control or under Sync mode control. Further, FIG. 19 indicates that the three high-order bits are incremented upon each synchronization pulse and that the four low-order bits are incremented upon each sampling. Furthermore, FIG. 19 depicts an example of an operation that is performed in a case where the value of one byte is defined as the link data.

### Communication Processing

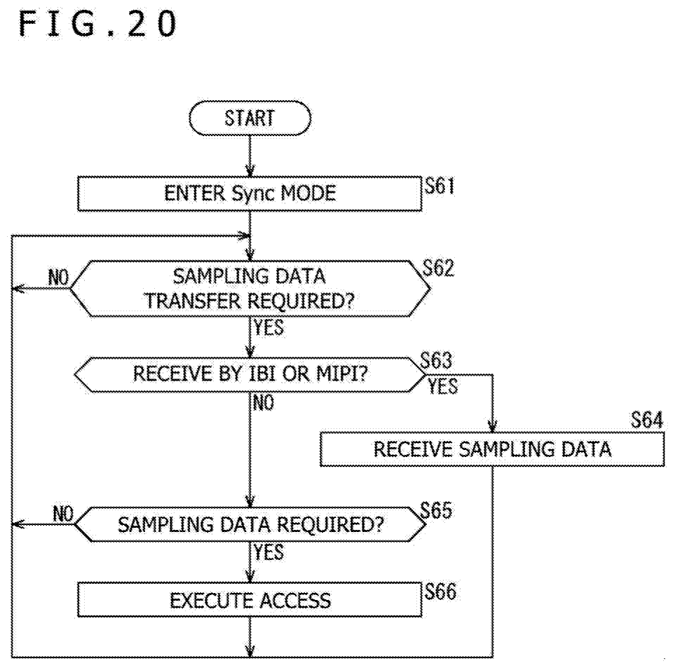

Communication processing performed in the second embodiment will now be described with reference to FIGS. 20 to 23.

FIG. 20 is a flowchart illustrating a communication process that is performed by the I3C master 21 in accordance with the conventional communication method.

In step S61, the I3C master 21 starts communicating with the I3C slave 22 in the Sync mode.

In step S62, the I3C master 21 determines whether or not a sampling data transfer is required, and stands by for processing until it is determined that the sampling data transfer is required. Subsequently, in a case where the I3C master 21 determines that the sampling data transfer is required, the processing proceeds to step S63.

In step S63, the I3C master 21 determines whether or not to receive sampling data by the IBI or by the MIPI.

In a case where the I3C master 21 determines, in step S63, to receive the sampling data either by the IBI or by the MIPI, the processing proceeds to step S64. In step S64, the I3C master 21 receives the sampling data by the IBI or by the MIPI. Upon completion of step S64, the processing returns to step S62. In step S62 and beyond, the processing is repeatedly performed in a similar manner.

Meanwhile, in a case where the I3C master 21 determines, in step S63, not to receive the sampling data by the IBI or by the MIPI, the processing proceeds to step S65.

In step S65, the I3C master 21 determines whether or not the sampling data is required. In a case where it is determined that the sampling data is not required, the processing returns to step S62. In step S62 and beyond, the processing is repeatedly performed in the similar manner.

Meanwhile, in a case where the I3C master 21 determines, in step S65, that the sampling data is required, the processing proceeds to step S66. In step S66, the I3C master 21 executes access in order to request the I3C slave 22 to read out the sampling data, and receives the sampling data as a result of the access. Subsequently, the processing returns to step S62. In step S62 and beyond, the processing is repeatedly performed in the similar manner.

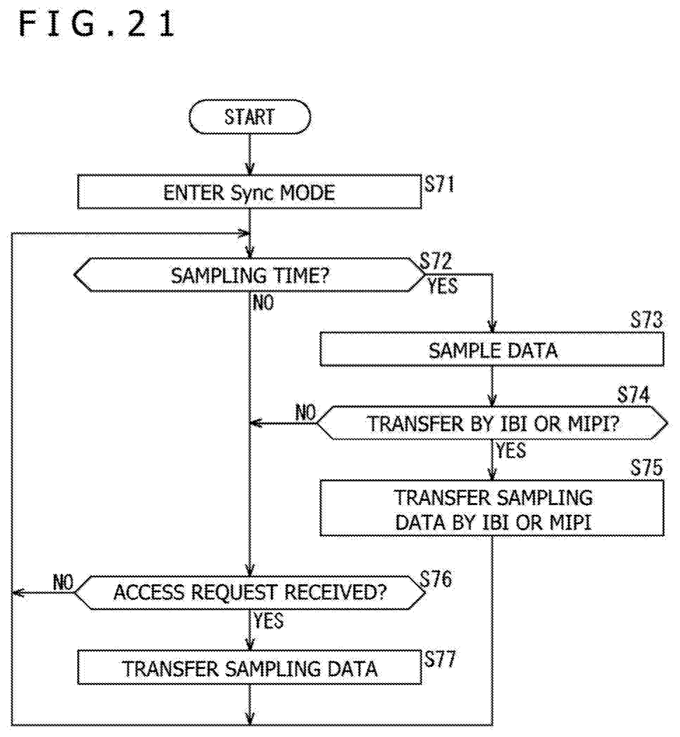

FIG. 21 is a flowchart illustrating a communication process that is performed by the I3C slave 22 in accordance with the conventional communication method.

In step S71, the I3C slave 22 starts communicating with the I3C master 21 in the Sync mode.

In step S72, the I3C slave 22 determines whether or not a sampling time has arrived. In a case where it is determined, in step S72, that the sampling time has arrived, the processing proceeds to step S73.

In step S73, the I3C slave 22 samples data to generate sampling data.

In step S74, the I3C slave 22 determines whether or not to transmit the sampling data by the IBI or by the MIPI.

In step S74, in a case where the I3C slave 22 determines to transmit the sampling data either by the IBI or by the MIPI, the processing proceeds to step S75. In step S75, the I3C slave 22 transfers the sampling data by the IBI or by the MIPI. Upon completion of step S75, the processing returns to step S72. In step S72 and beyond, the processing is repeatedly performed in a similar manner.

Meanwhile, in a case where it is determined, in step S72, that the sampling time has not arrived or it is determined, in step S74, not to transmit the sampling data by the IBI or by the MIPI, the processing proceeds to step S76.

In step S76, the I3C slave 22 determines whether or not an access request for reading out the sampling data is received. In a case where it is determined, in step S76, that the access request is not received, the processing returns to step S72. In step S72 and beyond, the processing is repeatedly performed in the similar manner.

Meanwhile, in a case where the I3C slave 22 determines, in step S76, that the access request for reading out the sampling data is received, the processing proceeds to step S77. In step S77, the I3C slave 22 transfers the sampling data in response to the access request from the I3C master 21. Subsequently, the processing returns to step S72. In step S72 and beyond, the processing is repeatedly performed in a similar manner.

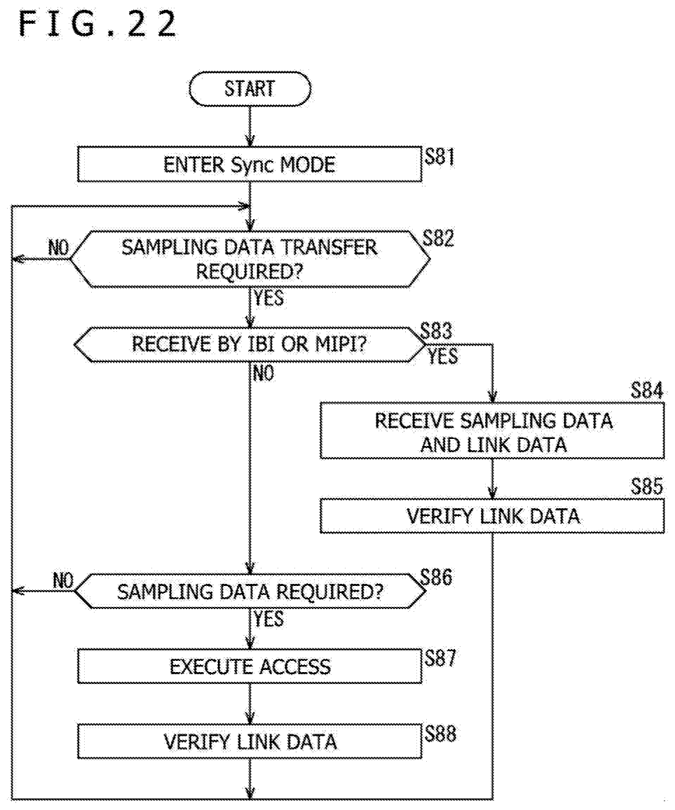

FIG. 22 is a flowchart illustrating a communication process that is performed by the I3C master 21 in accordance with the communication method to which the present technology is applied.

In steps 81 to 83, the processing is performed in a similar manner to the processing in steps S61 to S63 of FIG. 20. In a case where the I3C master 21 determines, in step S83, to receive the sampling data either by the IBI or by the MIPI, the processing proceeds to step S84.

In step S84, the I3C master 21 receives the sampling data and the link data by the IBI or by the MIPI. In step S85, the I3C master 21 verifies the link data. Upon completion of step S85, the processing returns to step S82. In step S82 and beyond, the processing is repeatedly performed in a similar manner.

In step S86, the processing is performed in a similar manner to the processing in step S65 of FIG. 20.

In step S87, the I3C master 21 executes access in order to request the I3C slave 22 to read out the sampling data, and receives the sampling data and the link data as a result of the access. In step S88, the I3C master 21 verifies the link data. Upon completion of step S88, the processing returns to step S82. In step S82 and beyond, the processing is repeatedly performed in the similar manner.

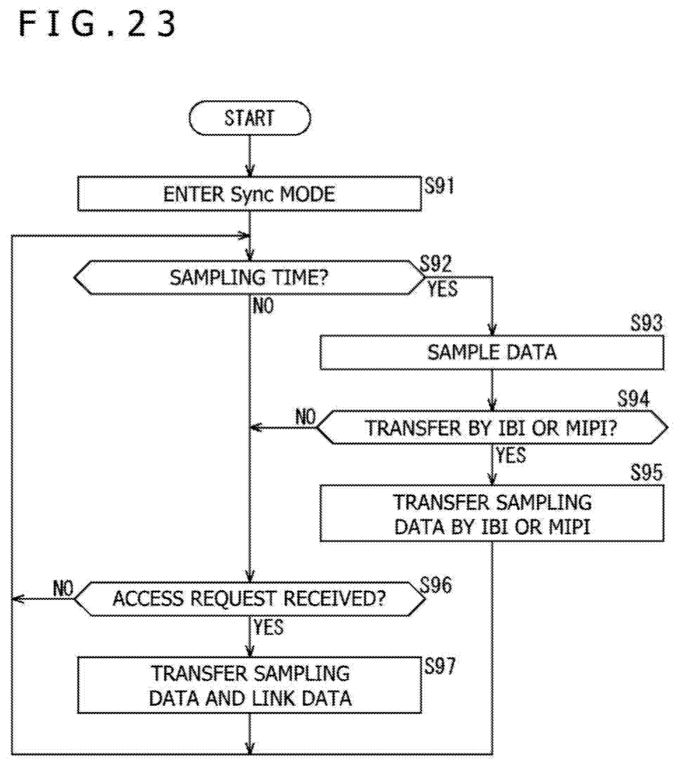

FIG. 23 is a flowchart illustrating a communication process that is performed by the I3C slave 22 in accordance with the communication method to which the present technology is applied.

In steps S91 to S94, the processing is performed in a similar manner to the processing in steps S71 to S74 of FIG. 21. In step S95, the I3C slave 22 transfers the sampling data and the link data by the IBI or by the MIPI. Upon completion of step S95, the processing returns to step S92. In step S92 and beyond, the processing is repeatedly performed in a similar manner.

In step S96, the processing is performed in a similar manner to the processing in step S76 of FIG. 21.

In step S97, the I3C slave 22 transfers the sampling data and the link data in response to the access request from the I3C master 21. Subsequently, the processing returns to step S92. In step S92 and beyond, the processing is repeatedly performed in the similar manner.

### Configuration Example of Application Processor and Sensor Device

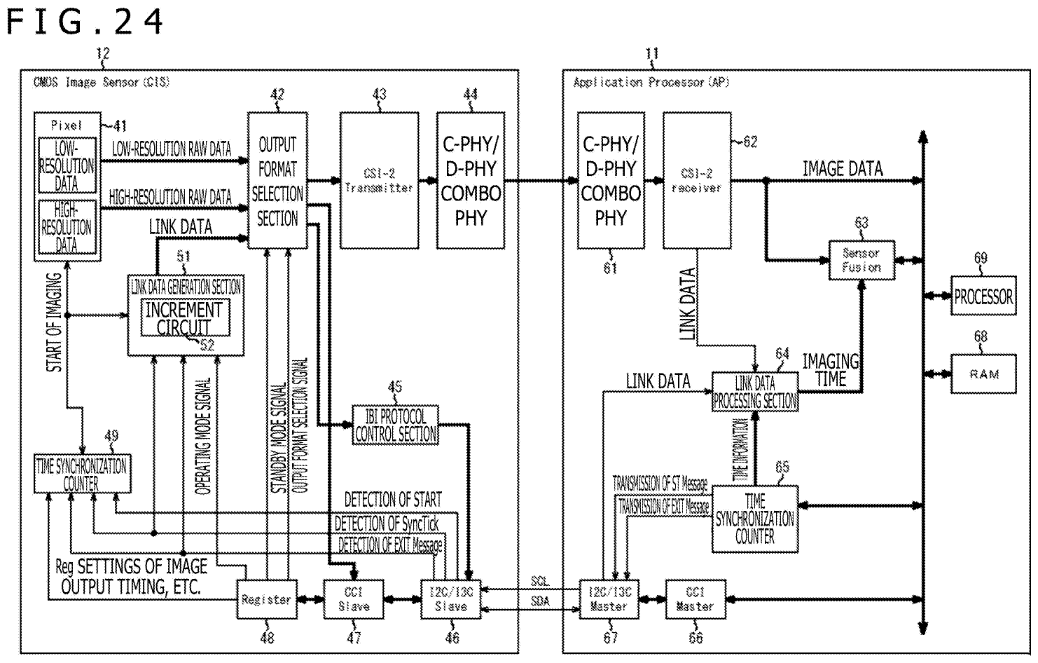

FIG. 24 is a block diagram illustrating a configuration example of the application processor 11 and the sensor device 12.

As depicted in FIG. 24, the sensor device 12 includes the pixels 41, the output format selection section 42, the CSI-2 transmitter 43, the combo physical layer 44, the IBI protocol control section 45, the I2C/I3C slave 46, the CCI slave 47, the register 48, the time synchronization counter 49, and the link data generation section 51. Further, the link data generation section 51 includes the increment circuit 52.

The application processor 11 includes the combo physical layer 61, the CSI-2 receiver 62, the sensor fusion section 63, the link data processing section 64, the time synchronization counter 65, the CCI master 66, the I2C/I3C master 67, the RAM 58, and the processor 59.

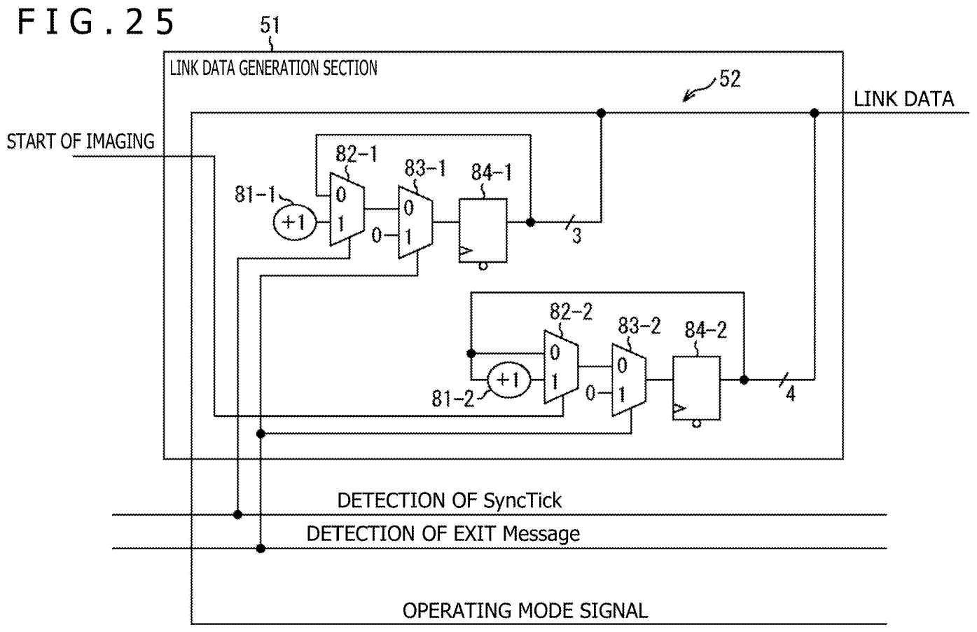

FIG. 25 is a circuit diagram illustrating a detailed configuration example of the link data generation section 51.

As depicted in FIG. 25, the increment circuit 52 included in the link data generation section 51 includes adders 81-1 and 81-2, selection sections 82-1 and 82-2, selection sections 83-1 and 83-2, and latches 84-1 and 84-2.

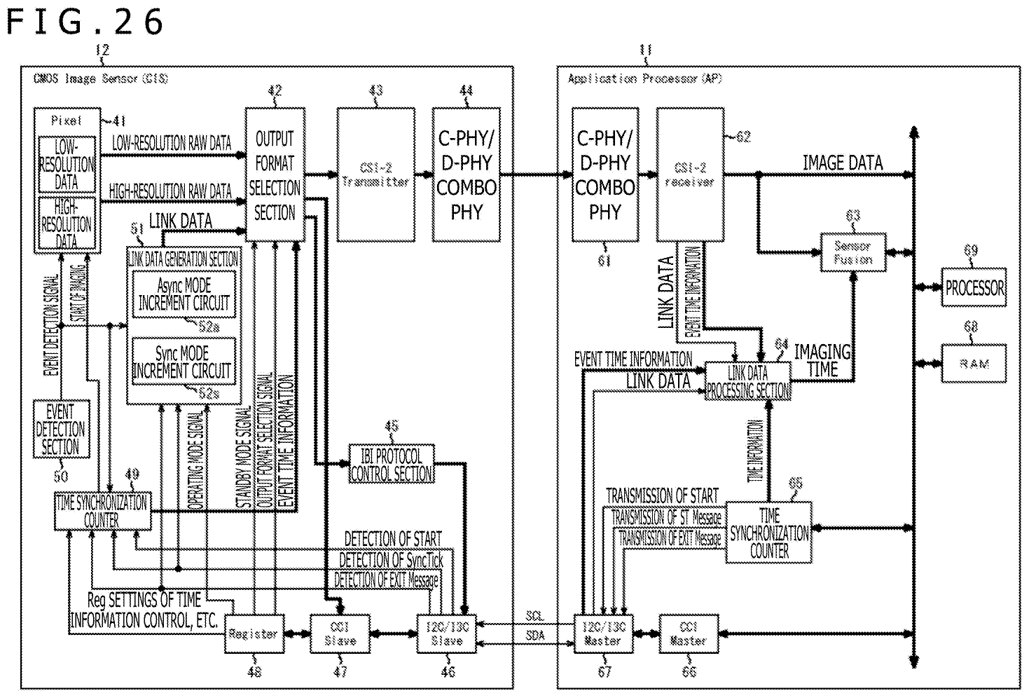

FIG. 26 is a block diagram illustrating a configuration example of the application processor 11 and the sensor device 12, which support both the Async mode and the Sync mode.

As depicted in FIG. 26, the sensor device 12 includes the pixels 41, the output format selection section 42, the CSI-2 transmitter 43, the combo physical layer 44, the IBI protocol control section 45, the I2C/I3C slave 46, the CCI slave 47, the register 48, the time synchronization counter 49, the event detection section 50, and the link data generation section 51. Further, the link data generation section 51 includes an Async mode increment circuit 52a and a Sync mode increment circuit 52s.

The application processor 11 includes the combo physical layer 61, the CSI-2 receiver 62, the sensor fusion section 63, the link data processing section 64, the time synchronization counter 65, the CCI master 66, the I2C/I3C master 67, the RAM 58, and the processor 59.

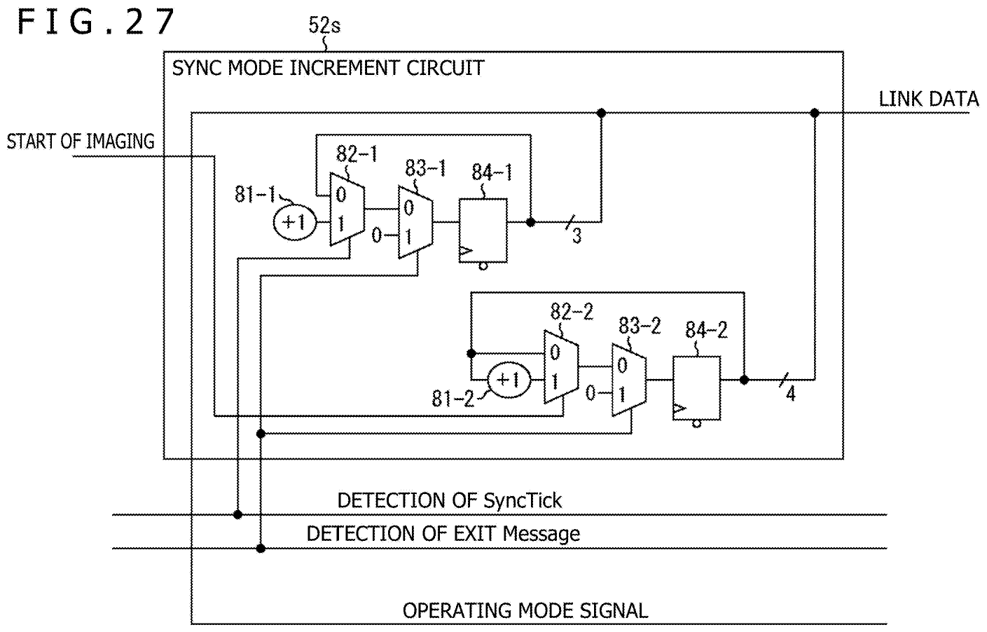

FIG. 27 is a circuit diagram illustrating a detailed configuration example of the Sync mode increment circuit 52s.

As depicted in FIG. 27, the Sync mode increment circuit 52s includes the adders 81-1 and 81-2, the selection sections 82-1 and 82-2, the selection sections 83-1 and 83-2, and the latches 84-1 and 84-2.

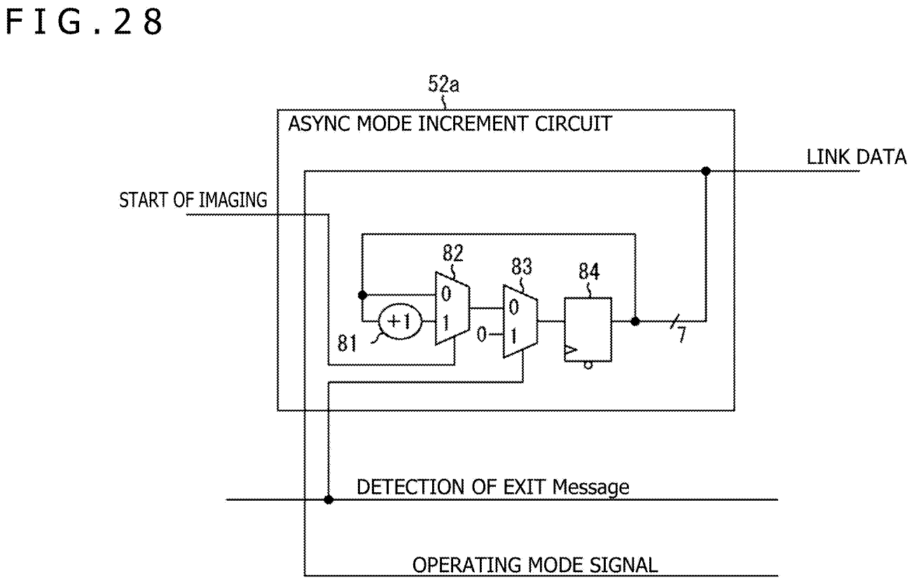

FIG. 28 is a circuit diagram illustrating a detailed configuration example of the Async mode increment circuit 52a.

As depicted in FIG. 28, the Async mode increment circuit 52a includes the adders 81-1 and 81-2, the selection sections 82-1 and 82-2, the selection sections 83-1 and 83-2, and the latches 84-1 and 84-2.

### Configuration Example of Computer

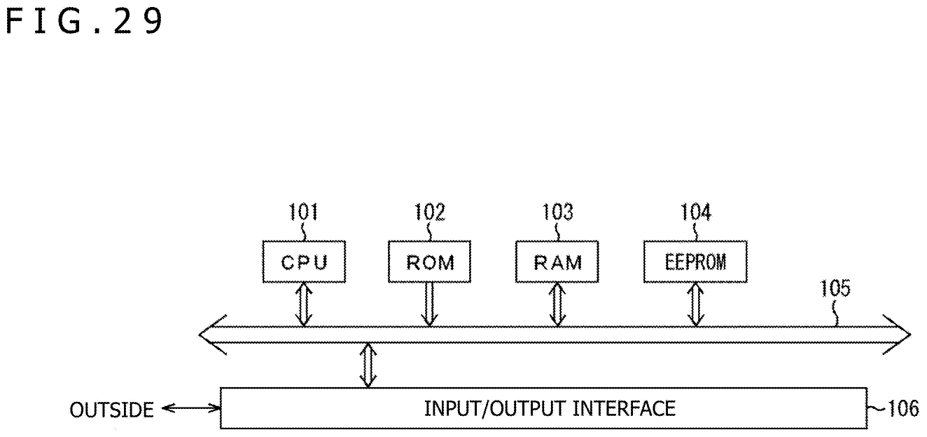

FIG. 29 is a block diagram illustrating a hardware configuration example of a computer that performs the above-described series of processes by executing a program.

In the computer, a CPU (Central Processing Unit) 101, a ROM (Read Only Memory) 102, a RAM (Random Access Memory) 103, and an EEPROM (Electronically Erasable and Programmable Read Only Memory) 104 are interconnected with a bus 105. The bus 105 is further connected to an input/output interface 106. The input/output interface 106 is connected to the outside.

The computer, which is configured as described above, performs the above-described series of processes by allowing the CPU 101 to load the program, which is stored, for example, in the ROM 102 or the EEPROM 104, into the RAM 103 through the bus 105 and execute the loaded program. Further, the program to be executed by the computer (CPU 101) may be written in advance in the ROM 102 or installed in the EEPROM 104 from the outside through the input/output interface 106 and updated.

Here, the processes to be performed by the computer in accordance with the program as described in the present document need not always be conducted in a chronological order described by a flowchart. That is, the processes to be performed by the computer in accordance with the program include processes that are conducted parallelly or individually (e.g., parallel processes or object-based processes).

Further, the program may be processed by a single computer (processor) or processed in a distributed manner by multiple computers. Furthermore, the program may be transferred to and executed by a remote computer.

Moreover, the term “system” used in the present document denotes an aggregate of multiple component elements (e.g., apparatuses and modules (parts)), and is applicable no matter whether or not all the component elements are within the same housing. Therefore, the term “system” denotes not only multiple apparatuses accommodated in separate housings and connected through a network, but also a single apparatus including multiple modules accommodated in a single housing.

Further, for example, a configuration described as the configuration of a single apparatus (or a processing section) may be divided and formulated as the configuration of multiple apparatuses (or processing sections). Conversely, a configuration described earlier as the configuration of multiple apparatuses (or processing sections) may be formulated as the configuration of a single apparatus (or a processing section). Furthermore, a configuration other than those described earlier may be obviously added to the configuration of each apparatus (or each processing section). Moreover, a part of the configuration of an apparatus (or a processing section) may be included in the configuration of another apparatus (or another processing section) as long as the overall system configuration and operation substantially remain unchanged.

Further, for example, the present technology may be configured for cloud computing in which one function is shared by multiple apparatuses through a network in order to perform processing in a collaborative manner.

Furthermore, for example, the above-mentioned program may be executed in any apparatus. In such a case, an apparatus executing the program is only required to have necessary functions (e.g., necessary functional blocks) for acquiring necessary information.

Moreover, individual steps described with reference to the foregoing flowcharts can be not only performed by one apparatus but also performed in a shared manner by multiple apparatuses. Additionally, in a case where multiple processes are included in a single step, the plurality of processes included in such a single step can be not only performed by one apparatus but also performed in a shared manner by multiple apparatuses. Stated differently, multiple processes included in a single step may be performed as processes in multiple steps. Conversely, processes described in conjunction with multiple steps may be performed together in a single step.

It should be noted that the program to be executed by the computer may be such that the processes in the steps describing the program are performed chronologically in the order described in the present document, performed parallelly, or performed individually at a necessary timing when, for example, a call is made. That is, the processes in the individual steps may be performed in an order different from the above-described order as long as no contradiction arises. Further, the processes in the steps describing the program may be performed in parallel with or in combination with the processes in another program.

It should also be noted that multiple pieces of the present technology described in the present document can be implemented independently on an individual basis as long as no contradiction arises. Obviously, any of the plurality of pieces of the present technology may be implemented in combination. For example, a part or the whole of the present technology described in conjunction with one of the embodiments can be implemented in combination with a part or the whole of the present technology described in conjunction with another embodiment. Further, a part or the whole of the present technology described above can be implemented in combination with another technology not described above.

### Combination Examples of Configurations

It should be noted that the present technology can further adopt the following configurations.

(1)

A communication apparatus including:

a link data generation section that generates link data for linking sampling data to a timing at which the sampling data is generated; and

a transmission section that appends the link data to the sampling data and transmits the resulting data to another communication apparatus through a bus.

(2)

The communication apparatus as described in (1) above, further including:

a time information generation section that generates time information indicating an occurrence time of an event that initiates sampling of the sampling data, in which

the link data links the time information to the sampling data.

(3)

The communication apparatus as described in (2) above, in which the transmission section transmits the time information and the link data by performing a data transfer with an interrupt request to the other communication apparatus, and transmits the sampling data and the link data in response to an access request from the other communication apparatus.

(4)

The communication apparatus as described in (3) above, in which the transmission section transmits the time information and the link data by using an IBI (In Band Interrupts) protocol of an I3C (Improved Inter Integrated Circuit).

(5)

The communication apparatus as described in (4) above, in which the transmission section transmits the sampling data and the link data by using the IBI protocol or an MIPI (Mobile Industry Processor Interface) protocol.

(6)

The communication apparatus as described in any one of (1) to (5) above, in which the sampling data and the time information are parallelly generated by making a timing at which the generation of the sampling data starts coincide with a timing at which generation of time information indicating the generation start time of the sampling data starts.

(7)

The communication apparatus as described in any one of (1) to (6) above, in which the link data links the sampling data generated by sampling performed at periodic timings to a sampling timing at which the sampling data is sampled.

(8)

A communication method causing a communication apparatus to perform:

generating link data for linking sampling data to a timing at which the sampling data is generated; and

appending the link data to the sampling data and transmitting the resulting data to another communication apparatus through a bus.

(9)

A program causing a computer of a communication apparatus to perform a communication process including:

generating link data for linking sampling data to a timing at which the sampling data is generated; and

appending the link data to the sampling data and transmitting the resulting data to another communication apparatus through a bus.

It should be noted that the embodiments of the present technology are not limited to the above-described embodiments, and can be variously modified without departing from the scope and spirit of the present disclosure. Further, advantages described in the present document are merely illustrative and not restrictive. The present disclosure may additionally provide advantages other than those described in the present document.

### REFERENCE SIGNS LIST

11: Application processor
12: Sensor device
21: I3C master
22: I3C slave
23: Sensor

1. A communication apparatus comprising:
a link data generation section that generates link data for linking sampling data to a timing at which the sampling data is generated; and
a transmission section that appends the link data to the sampling data and transmits the resulting data to another communication apparatus through a bus.

2. The communication apparatus according to claim 1, further comprising:
a time information generation section that generates time information indicating an occurrence time of an event that initiates sampling of the sampling data, wherein
the link data links the time information to the sampling data.

3. The communication apparatus according to claim 2, wherein the transmission section transmits the time information and the link data by performing a data transfer with an interrupt request to the other communication apparatus, and transmits the sampling data and the link data in response to an access request from the other communication apparatus.

4. The communication apparatus according to claim 3, wherein the transmission section transmits the time information and the link data by using an IBI (In Band Interrupts) protocol of an I3C (Improved Inter Integrated Circuit).

5. The communication apparatus according to claim 4, wherein the transmission section transmits the sampling data and the link data by using the IBI protocol or an MIPI (Mobile Industry Processor Interface) protocol.

6. The communication apparatus according to claim 1, wherein the sampling data and the time information are parallelly generated by making a timing at which the generation of the sampling data starts coincide with a timing at which generation of time information indicating the generation start time of the sampling data starts.

7. The communication apparatus according to claim 1, wherein the link data links the sampling data generated by sampling performed at periodic timings to a sampling timing at which the sampling data is sampled.

8. A communication method causing a communication apparatus to perform:
generating link data for linking sampling data to a timing at which the sampling data is generated; and
appending the link data to the sampling data and transmitting the resulting data to another communication apparatus through a bus.

9. A program causing a computer of a communication apparatus to perform a communication process including:
generating link data for linking sampling data to a timing at which the sampling data is generated; and
appending the link data to the sampling data and transmitting the resulting data to another communication apparatus through a bus.
